(19) United States
(12) Patent Application Publication
(10) Pub. No.: US 2026/0365186 A1
(43) Pub. Date: Nov. 19, 2026

(54) METHOD AND CONTROL UNIT FOR PROVIDING A FUNCTIONALITY IN A VEHICLE

(71) Applicant: Robert Bosch GmbH, Stuttgart (DE)

(72) Inventors: Paulius Duplys, Markgroeningen (DE); Christian Zimmermann, Stuttgart (DE); Holger Niemann, Ludwigsburg (DE)

(21) Appl. No.: 19/666,882

(22) Filed: May 4, 2026

(30) Foreign Application Priority Data
May 19, 2025 (DE) 10 2025 119 297.9

(51) Int. Cl. B60W 50/023; B60W 50/02; G05B 15/02

(52) U.S. Cl. CPC B60W 50/023; B60W 50/0205; G05B 15/02

(57) ABSTRACT

A method for providing a functionality in a vehicle, in particular a software-defined vehicle. At least two different software modules, in particular two software agents, are executed on a control unit in order to control access to the functionality; and the functionality is provided by each of the software modules via its own pair of communication channels. The communication channels within a pair are redundantly designed.

### CROSS REFERENCE

The present application claims the benefit under 35 U.S.C. § 119 of Germany Patent Application No. DE 10 2025 119 297.9 filed on May 19, 2025, which is expressly incorporated herein by reference in its entirety.

### FIELD

The present disclosure relates to a method and a control unit for providing a functionality in a vehicle, in particular a software-defined vehicle, to a computer program and to a computer-readable storage medium.

### BACKGROUND INFORMATION

Modern vehicles, in particular software-defined vehicles (SDVs), are characterized by increasing networking and complexity of the software. This presents new challenges regarding vehicle security, since the attack surface for cyberattacks increases. A promising approach for securing vehicles is the zero trust architecture (ZTA), which is based on the principle of "Never trust, always verify."

Conventional implementations of ZTA, as from enterprise IT, rely on massive redundancy in order to ensure availability of services. Failure of a single server or a virtual machine is compensated for by other, identical systems. However, this approach is often unsuitable for safety-critical applications in vehicles, since resources (computing power, memory, energy) are limited and redundancy represents a high cost factor.

Germany Patent Application No. DE 10 2024 212 179.7 describes a method for providing a function in a vehicle, in particular a software-defined vehicle (SDV), wherein at least two different software modules are used on a control unit and each of the at least two different software modules provides the function via its own, separate communication interface.

### SUMMARY

A method, a control unit for a vehicle, a computer program, and a computer-readable medium are provided according to the present disclosure.

The method of the present disclosure relates to providing a functionality in a vehicle, in particular in a software-defined vehicle (SDV). An SDV can be understood as a vehicle of which the functions are to a large extent software-based. Within the framework of the method, at least two software modules are executed on a control unit. A control unit can be understood as an electronic control unit in the vehicle that is responsible for execution of specific functions. The software modules, alternatively also referred to as software agents, serve to control access to the provided functionality. The functionality can vary depending on the application case and can, for example, comprise control of a powertrain, a brake system or a driver assistance function. Likewise, the functionality can relate to providing data for a human-machine interface or communication with other control units in the vehicle. Each software module provides the functionality via its own pair of communication channels. A communication channel can, for example, be a network connection, a memory region in the control unit or a dedicated hardware connection.

According to an example embodiment, in the method, the communication channels within a pair are redundantly designed. Here, redundancy can mean that both channels within a pair fulfill the same function and transmit data along the same path. In the event of failure of one channel, the other channel can continue to ensure communication. For example, both channels within a pair can use the same network connection, but be routed via different physical ports or lines. Another possibility would be implementation of both channels on different, but functionally equivalent, hardware components in the control unit.

The redundant design of the communication channels increases the reliability of the system. If a communication channel fails, for example due to a hardware defect, a disturbance or an attack, the functionality can continue to be provided via the redundant channel. This is particularly relevant for safety-critical applications in the vehicle, in which failure of the functionality can lead to dangerous situations. Thus, the redundant communication channels contribute to increasing availability and safety in the vehicle.

The redundant design of the communication channels increases the reliability of the system. According to an example embodiment, if a communication channel fails, for example due to a hardware defect, a disturbance or an attack, the functionality can continue to be provided via the redundant channel. This is particularly relevant for safety-critical applications in the vehicle, in which failure of the functionality can lead to dangerous situations. Thus, the redundant communication channels contribute to increasing availability and safety in the vehicle.

Further advantages can be found in the disclosure herein.

In a preferred example embodiment, the at least two software modules are implemented identically or differently. In this connection, "implemented identically" means that both agents execute the same program code and use the same algorithms and data structures. By contrast, "implemented differently" means that the agents execute different program code or use different algorithms and data structures. For example, one agent could be implemented in the programming language C++, while the other agent is implemented in Python. Alternatively, both agents could be implemented in the same programming language, but use different algorithms for data processing.

The possibility of using both identical and different software agents increases the flexibility of the method. The use of identical agents can reduce implementation effort, since only one program code has to be developed and maintained. The use of different agents can, by contrast, increase the robustness of the system, since different implementations may not be affected by the same errors or vulnerabilities. The selection between identical and different agents can be made depending on the specific requirements of the application case.

In a further preferred example embodiment, the software modules are configured as zero-trust agents (ZTA) in order to control access to the functionality on the basis of zero-trust agent policies. A ZTA can be understood as a security concept based on the principle of "Never trust, always verify." In contrast to traditional security models, which often rely on a trust relationship within a network, ZTA assumes that each device and each software process is potentially insecure. Therefore, each access to the functionality must be explicitly authorized, regardless of the location of the requester. A zero-trust agent policy can define rules and criteria that must be satisfied for authorization of access. Examples of such criteria can be authentication of the requester, integrity verification of the requesting system or verification of access rights.

By configuring the software modules as ZTA, security of the system is increased. Each access to the functionality is controlled by the ZTA agents and verified on the basis of the defined policies. As a result, the risk of unauthorized access and attacks is minimized. This is particularly important in safety-critical applications in vehicles, where unauthorized access can have serious consequences.

In a further preferred example embodiment, the communication channels use different protocols. A protocol can be understood as a set of rules and conventions that regulate data exchange between the software modules and the functionality. Examples of protocols include TCP/IP, UDP, CAN, or FlexRay. Different protocols can have different properties in relation to security, real-time capability, bandwidth or robustness. For example, TCP/IP can provide high reliability, while UDP allows lower latency. CAN can be regarded as a robust protocol for communication in real-time systems, while FlexRay provides even higher bandwidth and determinism.

The use of different protocols for the communication channels can increase the robustness of the system with respect to attacks. If an attacker exploits a vulnerability in a specific protocol, the other communication channels that use a different protocol may not be affected by this vulnerability. As a result, the functionality can continue to be provided even in the event of a successful attack on one communication channel. Thus, the use of different protocols increases the reliability and security of the system.

In a further preferred example embodiment, the communication channels use different physical transmission layers. A physical transmission layer can be understood as the physical connection between the software modules and the functionality. Examples of physical transmission layers are wired connections such as Ethernet cables or optical fibers, but also wireless connections such as WLAN, Bluetooth or cellular communication. Different physical transmission layers can have different properties in relation to bandwidth, range, interference immunity or cost. For example, Ethernet can provide high bandwidth and reliability for short distances, while WLAN allows greater flexibility in networking. Bluetooth can be suitable for communication over short distances with low energy consumption, while cellular communication provides a large range.

The use of different physical transmission layers for the communication channels can further increase the robustness of the system. If a specific physical transmission layer fails due to external influences, such as, e.g., electromagnetic interference or cable breakage, the other communication channels that use a different physical transmission layer can continue to operate. Thus, the use of different physical layers increases the reliability and independence of the system.

In a further preferred example embodiment, the state of the software modules and the communication channels is monitored. The state of a software module can, for example, be understood as its functionality, its performance or its resource consumption. The state of a communication channel can, for example, comprise its availability, its bandwidth or its error rate. Monitoring can be carried out by various measures, such as, for example, regular self-tests of the software modules, sending test data via the communication channels or analysis of log files.

By monitoring the state of the software modules and the communication channels, potential problems can be recognized at an early stage. If, for example, a software module no longer functions correctly or a communication channel fails, this can be recognized by monitoring. Based on the results of monitoring, suitable measures can then be taken in order to restore the functionality of the system. Thus, monitoring contributes to increasing reliability and stability of the system.

In a further preferred example embodiment, the monitoring is performed by a system health monitor (SHM). An SHM can be understood as a dedicated software or hardware component that is responsible for monitoring the state of the software modules and the communication channels. The SHM can perform the monitoring measures described in the above-described embodiment, such as, for example, self-tests of the software modules, sending test data via the communication channels or analysis of log files. Additionally, the SHM can evaluate and aggregate the collected data in order to obtain a comprehensive overview of the state of the system.

The use of an SHM can increase the efficiency and reliability of the monitoring. By centralized performance of the monitoring measures in the SHM, the effort for the individual software modules is reduced. The SHM can additionally be optimized specifically for the monitoring tasks and can, for example, use complex algorithms for error detection and prediction. Thus, the use of an SHM contributes to improving monitoring quality and relieving the load on the software modules.

In a further preferred example embodiment, the SHM centrally manages security policies and distributes them to the software modules, wherein the security policies in particular comprise zero-trust agent policies. Security policies can be understood as rules and configurations that control behavior of the software modules and regulate access to the functionality. Zero-trust agent policies can, for example, define which conditions a software module must satisfy in order to be permitted to access specific resources or data. The SHM can store the security policies in a central database or a configuration file and distribute them to the software modules if required.

Centralized management of the security policies by the SHM can increase the consistency and flexibility of the system. Due to the centralized storage of the policies, it is ensured that all software modules use the same rules. Changes to the policies need to be made only once in the SHM and are then automatically distributed to all software modules. This simplifies administration and reduces effort for the configuration of the individual software modules.

In a further preferred example embodiment, upon recognition of an error of a software module or of a communication channel, the provision of the functionality is switched to another software module or another communication channel pair. An error can, for example, be failure of a software module, an incorrect output of a software module or a failure of a communication channel. The recognition of the error can be carried out by the monitoring measures described in the above-described embodiments. Switching to another software module or another communication channel pair can be carried out automatically by the SHM or by another mechanism.

By switching to a redundant component in the event of an error, the availability of the functionality is increased. Even if a software module or a communication channel fails, the functionality can continue to be provided by switching to a functioning module or channel pair. This increases the robustness of the system and minimizes effects of errors.

In a further preferred example embodiment, more than two software modules are executed. Instead of using only two software modules, for example three, four or more modules can be used for providing the functionality. Each of these modules can provide the functionality via its own pair of communication channels, and the communication channels within a pair can be redundantly designed. The modules can differ in their implementation details, for example by use of different programming languages, algorithms or data structures.

The use of more than two software modules increases the redundancy and thus reliability of the system. If a plurality of modules or communication channels fail, the remaining modules can continue to provide the functionality. The increased redundancy thus provides additional protection against failures and increases the availability of the system.

The aforementioned advantages apply correspondingly to a control unit for a vehicle, in particular a software-defined vehicle (SDV), which is configured to execute the method according to one of the aforementioned embodiments. Such a control unit can comprise the necessary hardware and software components in order to execute the described steps of the method. It can, for example, comprise at least two different software modules, which each provide the functionality via its own pair of redundant communication channels. The control unit can additionally comprise a system health monitor (SHM), which monitors the state of the software modules and the communication channels and, in the event of an error, switches the provision of the functionality to a redundant component. The security policies, in particular the ZTA policies, can be centrally managed by the SHM and distributed to the software modules.

Such a control unit can use the advantages of redundancy and diversity in order to increase the availability and security of the provided functionality. By executing a plurality of software modules and using redundant communication channels, the control unit can continue to function even in the event of failures of individual components. Monitoring by the SHM and the centralized management of the security policies increase the robustness and flexibility of the system. The present disclosure thus allows the implementation of a secure and reliable control unit for safety-critical applications in the vehicle.

The subject matter of the present disclosure is also a computer program or computer program product, comprising instructions which, when the computer program is executed by a computer or by the control unit according to one of the aforementioned example embodiments, cause the computer or the control unit to execute at least one or all steps of the method according to one of the aforementioned example embodiments. The computer program or computer program product can be stored on a machine-readable, in particular non-volatile carrier or storage medium such as a semiconductor memory, a hard disk storage or an optical storage.

The subject matter of the present disclosure is also a computer-readable medium on which the above-described computer program is stored.

The term "computer-readable medium" can be understood as a physical medium that stores information in a form that can be read and processed by a computer or another electronic device. Such a medium can, for example, be a CD-ROM, a DVD, a USB stick, a hard disk or another storage medium that stores digital data. The medium can comprise both magnetic and optical storage media and can be present in various formats, such as, for example, as a file, as a program or as an operating system. The medium can also be used as part of a larger system or a larger device, such as, for example, as part of a computer or a control unit in a vehicle. In any case, the computer-readable medium allows the transfer of information between different electronic devices and execution of programs or applications on these devices.

### BRIEF DESCRIPTION OF THE DRAWINGS

Exemplary embodiments of the present disclosure are illustrated schematically in the figures and explained in more detail in the following description. The same reference signs are used for the elements which are shown in the various figures and act similarly, wherein a repeated description of the elements is dispensed with.

FIG. 1 is a schematic representation of a method, a control unit, a vehicle, a computer program and a storage medium according to an exemplary embodiment.

FIG. 2 is a schematic representation for the visualization of the present disclosure according to an exemplary embodiment.

FIG. 3 is a schematic representation for the visualization of the present disclosure according to a further exemplary embodiment.

### DETAILED DESCRIPTION OF EXAMPLE EMBODIMENTS

As already set forth above, the present disclosure describes a method, a control unit, a computer program and a storage medium, which allow the increasing availability of a functionality in a vehicle, in particular a software-defined vehicle (SDV), by redundancy and diversity of software modules and communication channels.

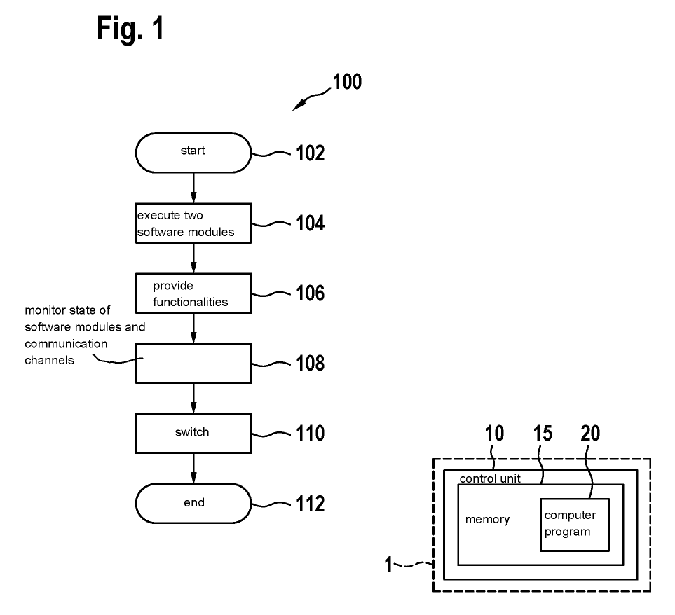

FIG. 1 shows on the left side a block diagram of the method 100 for providing a functionality in a vehicle 1, in particular a software-defined vehicle (SDV), which can be executed, for example, by a control unit 10 as shown on the right side. The control unit 10 can be configured as an electronic control unit in the vehicle 1, in particular a software-defined vehicle (SDV), on which the software modules are executed. The control unit 10 can comprise specific hardware components such as a processor, a memory 15, communication interfaces and, if applicable, further application-specific circuits. It can be responsible for the execution of specific functions in the vehicle 1, such as, for example, control of the powertrain, the brake system, the driver assistance systems or communication with other control units.

The computer program 20 comprises the program code for the software modules and the method 100. The computer program 20 can be written in any programming language and can use various algorithms and data structures. The software modules, which can also be referred to as software agents, are components of the computer program 20. They can fulfill different tasks, such as, for example, controlling access to the functionality, monitoring the system state or switching to redundant components in the event of an error. In a preferred embodiment, the software modules are configured as zero-trust agents (ZTA) in order to control access to the functionality on the basis of zero-trust policies.

The storage medium 15 serves for storing the computer program 20. The storage medium 15 can, for example, be a read-only memory, a flash memory, a magnetic hard disk or an optical storage medium. The computer program 20 can be loaded from the storage medium 15 into the control unit 10 and executed there by the processor of the control unit 10.

The control unit 10, the computer program 20 and the storage medium 15 together form a system that implements the described present disclosure. The control unit 10 provides the hardware platform on which the computer program 20 is executed. The computer program 20 contains the logic of the method 100 and controls the execution of the software modules. The storage medium 15 serves as a carrier for the computer program 20 and allows the permanent storage and distribution thereof.

The method 100 is started in step 102. In the next step 104, at least two software modules, which can be implemented identically or differently, are executed on a control unit. The software modules can alternatively also be referred to as software agents. In a preferred embodiment of the method, the software modules are configured as zero-trust agents (ZTA) in order to control access to the functionality on the basis of zero-trust policies.

Subsequently, in step 106, the functionality is provided by each software module via its own pair of redundant communication channels. The communication channels within a pair are redundantly designed. In a preferred embodiment, the communication channels use different protocols and different physical transmission layers in order to increase the robustness of the system.

Optionally, in step 108, the state of the software modules and communication channels can be monitored. Monitoring can be carried out by various mechanisms, for example by regular self-tests of the software modules, by sending test data via the communication channels or by analysis of log files. In a preferred embodiment, the monitoring is performed by a system health monitor (SHM). The SHM can evaluate the collected state data and, if required, initiate measures. In a further preferred embodiment, the SHM centrally manages security policies and distributes them to the software modules. The security policies can in particular comprise zero-trust agent policies.

Likewise optionally, in step 110, upon recognition of an error of a software module or of a communication channel, the provision of the functionality can be switched to another software module or another communication channel pair. The switching can be carried out automatically by the SHM or by another mechanism. In a preferred embodiment of the method, more than two software modules are executed in order to increase redundancy and reliability. The method 100 ends with step 112.

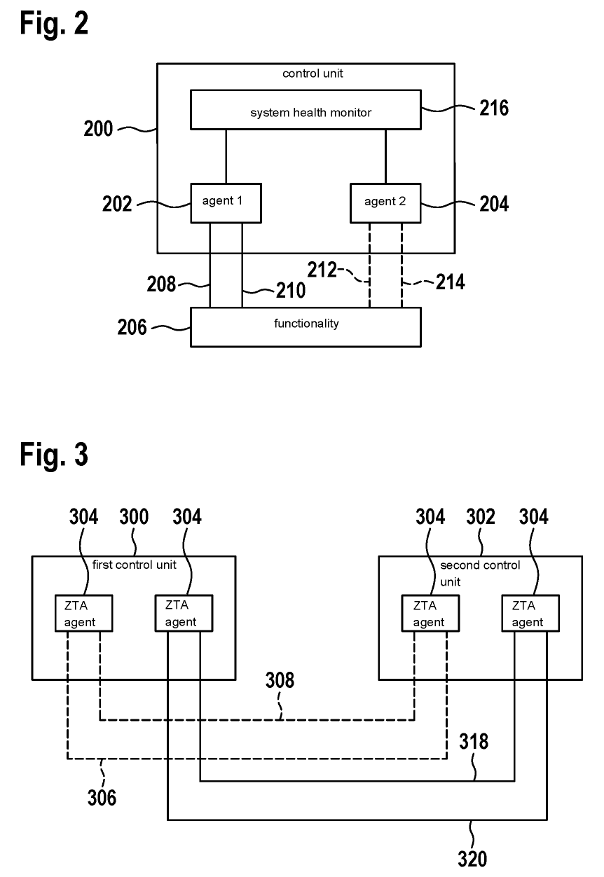

FIG. 2 shows an exemplary embodiment of the method 100 with two software modules on a control unit 200. The software modules agent 1 (202) and agent 2 (204) can be implemented identically or differently. In the example shown, the agents are implemented differently. For example, agent 1 (202) can be implemented in C++ and agent 2 (204) in Python, or they can use different algorithms or data structures. The use of different implementations increases the robustness of the system through diversity, since probability is reduced that both agents are affected by the same error. Alternatively, agent 1 (202) and agent 2 (204) can also be implemented identically, in order, for example, to reduce development effort.

Both agents 202 and 204 provide the functionality 206. The functionality 206 represents the service or function that is provided by the software modules. The connection between the agents and the functionality 206 is carried out via in each case two redundant communication channels, which increase the availability of the functionality even if one channel fails.

Agent 1 (202) communicates with the functionality 206 via the channels channel 1a (208) and channel 1b (210). Agent 2 (204) communicates with the functionality 206 via the channels channel 2a (212) and channel 2b (214). The diversity of the communication paths can advantageously be realized by different protocols and physical transmission layers. For example, channel 1a (208) and channel 1b (210) can use Ethernet, while channel 2a (212) and channel 2b (214) use CAN. As already mentioned, the diversity of the communication channels allows increased robustness with respect to attacks that target exploitation of vulnerabilities in specific network stacks. In this case, an attacker would have to develop separate exploits for different protocols, which significantly increases the complexity of an attack.

Optionally, a system health monitor (SHM) 216 monitors the state of the software modules agent 1 (202) and agent 2 (204) along with the state of the communication channels 208, 210, 212, 214. In the event of an error, for example triggered by an attack by means of an electromagnetic pulse, the SHM 216 can switch the provision of the functionality 206 to a functioning agent or a functioning channel pair, as a result of which the availability of the functionality 206 remains ensured. Furthermore, the SHM 216 can centrally manage the security policies, in particular the ZTA policies, and distribute them to the software modules.

FIG. 3 shows a further exemplary embodiment for illustrating the present disclosure. A first control unit 300 and a second control unit 302 each provide a service (not shown in the figure) that is to be protected by the architecture according to the present disclosure. Within each control unit 300, 302, two instances of the same ZTA agent 304 are located. Here, only one implementation of the ZTA agent is used. This can mean that all four instances of the ZTA agent 304 execute identical code.

Each instance of the ZTA agent 304 is connected to the particular service via two communication channels. The dashed lines represent redundant CAN communication channels 306, 308, while the solid lines represent redundant Ethernet communication channels 318, 320. For example, the dashed lines 306 and 308 in the first control unit 300 form a redundant pair of CAN channels. The solid lines 310 and 312 in the second control unit 302 form a redundant pair of Ethernet channels. The use of different protocols (CAN and Ethernet) increases security, since an attacker would have to attack two different types of network stacks in order to completely disrupt communication.

Even if an attacker attempts to disrupt communication, e.g., by means of an electromagnetic pulse, the service remains available as long as at least one channel within a pair functions. Up to three communication channels can fail without impairing availability of the service. The redundancy of the channel pairs and diversity of the protocols increase the robustness and security of the system.

What is claimed is:

1. A method for providing a functionality in a vehicle, the method comprising the following steps:
executing at least two software modules on a control unit to control access to the functionality; and
providing the functionality by each of the software modules via a respective pair of communication channels,
wherein the communication channels within each pair are redundant.

2. The method according to claim 1, wherein the vehicle is a software-defined vehicle (SDV).

3. The method according to claim 1, wherein the at least two software modules are identical or different.

4. The method according to claim 3, wherein the software modules are zero-trust agents (ZTA) to control access to the functionality based on zero-trust agent policies.

5. The method according to claim 1, wherein the communication channels use different protocols.

6. The method according to claim 1, wherein the communication channels use different physical transmission layers.

7. The method according to claim 4, wherein a state of the at least two software modules and of the communication channels is monitored.

8. The method according to claim 7, wherein the monitoring is performed by a system health monitor (SHM).

9. The method according to claim 8, wherein the SHM centrally manages security policies including the zero-trust agent policies, and distributes the security policies to the zero-trust agents.

10. The method according to claim 1, wherein, upon recognition of an error of a software module of the at least two software modules or of a communication channel of the communication channels, the provision of the functionality is switched to another software module or another communication channel pair.

11. The method according to claim 1, wherein the at least two software modules includes more than two software modules.

12. A control unit for a software-defined vehicle, the control unit configured to execute a method for providing a functionality in a software-defined vehicle, the method comprising the following steps:
executing at least two software modules on a control unit to control access to the functionality; and
providing the functionality by each of the software modules via a respective pair of communication channels,
wherein the communication channels within each pair are redundant.

13. A non-transitory computer-readable storage medium on which is stored a computer program for providing a functionality in a vehicle, the computer program, when executed by a computer, causing the computer to perform the following steps comprising:
executing at least two software modules on a control unit to control access to the functionality; and
providing the functionality by each of the software modules via a respective pair of communication channels,
wherein the communication channels within each pair are redundant.
